(19) United States
(12) Patent Application Publication
(10) Pub. No.: US 2024/0385324 A1
(43) Pub. Date: Nov. 21, 2024

(54) Systems And Methods For Using Doppler-Shifted Frequency To Measure Speed Of Current Or Object In Body Of Water

(71) Applicant: University of Alaska Fairbanks, Fairbanks, AK (US)

(72) Inventor: Michael R. Roddewig, Fairbanks, AK (US)

(21) Appl. No.: 18/667,087

(22) Filed: May 17, 2024

Related U.S. Application Data
(60) Provisional application No. 63/502,959, filed on May 18, 2023.

(51) Int. Cl. G01S 17/58; G01P 5/26; G01S 7/481; G01S 7/499; G01S 17/88

(52) U.S. Cl. CPC G01S 17/58; G01P 5/26; G01S 7/4816; G01S 7/499; G01S 17/88

(57) ABSTRACT

A method includes the step of emitting light from a laser emission source into a body of water. A reflection of the light can be received at a detector. A speed of a current in the body of water can be determined based on a Doppler-shifted frequency of the reflection of the light.

### CROSS-REFERENCE TO RELATED APPLICATION

This application claims priority to and the benefit of the filing date of U.S. Provisional Patent Application No. 63/502,959, filed May 18, 2023, the entirety of which is incorporated by reference herein.

### FIELD

This disclosure relates to systems and methods for measuring speed of water currents and/or an object in water using the Doppler-shifted frequency of a laser.

### BACKGROUND

It can be advantageous to determine the speed of a water current in bodies of water such as, for example, rivers, lakes, and oceans. However, such measurements typically require contact methods such as flow meters with propellers. Such methods have limited accuracy and can otherwise be difficult to use in certain situations. It can also be advantageous to measure the speed of objects in water.

### SUMMARY

Disclosed herein, in one aspect, is a method including the step of emitting light from a laser emission source into a body of water. A reflection of the light is received at a detector. The method further includes the step of determining, based on a Doppler-shifted frequency of the reflection of the light, one of: a speed of a current in the body of water; or a speed of an object in a body of water.

In another aspect, a system includes a laser emission source that is configured to emit light into a body of water. A detector is configured to receive a reflection of the light. A computing device is in communication with the detector. The computing device is configured to determine, based on a Doppler-shifted frequency of the reflection of the light, one of: a speed of a current in the body of water; or a speed of an object in a body of water.

Also disclosed herein is a system including a laser emission source that is configured to emit light into a body of water, the light having a wavelength from 200 nm to 800 nm. The system includes means for splitting the light from the laser emission source into a first portion and a second portion. A detector is configured to receive a reflection of the light. The system includes means for directing the first portion of the light from the laser emission source to the detector, the reflection of the light comprising a reflection of the second portion of the light from the laser emission source. The system further includes means for passing the reflection of the light through a polarizing filter. A computing device is in communication with the detector. The computing device is configured to determine, based on a Doppler-shifted frequency of the reflection of the light, one of: a speed of a current in the body of water; or a speed of an object in a body of water.

Additional advantages of the disclosed apparatuses, systems, and methods will be set forth in part in the description that follows, and in part will be obvious from the description, or may be learned by practice of the claimed invention. The advantages of the disclosed devices and systems will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

These and other features of the preferred embodiments of the invention will become more apparent in the detailed description in which reference is made to the appended drawings wherein:

FIG. 1 shows a block diagram of an exemplary system for measuring speed of water currents using Doppler-shifted frequency of a laser, as disclosed herein.

FIG. 2 shows a block diagram of an exemplary system for measuring speed of water currents using Doppler-shifted frequency of a laser, as disclosed herein, the system including a spectral filter.

FIG. 3 shows a block diagram of an exemplary system for measuring speed of water currents using Doppler-shifted frequency of a laser, as disclosed herein, the system including a beam splitter to provide a reference signal.

FIG. 4 shows a block diagram of an exemplary system for measuring speed of water currents using Doppler-shifted frequency of a laser, as disclosed herein, the system including a polarizing filter.

FIG. 5 shows a block diagram of an exemplary system for measuring speed of water currents using Doppler-shifted frequency of a laser, as disclosed herein, the system including a first polarizing filter that is coincident with a polarization of the light from the laser emission source and a second polarizing filter that is crossed with a polarization of the light from the laser emission source.

FIG. 6 shows a block diagram of an operating environment comprising a computing device as disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can include plural referents unless the context clearly dictates otherwise. For example, unless the context dictates otherwise, use of the term “a detector” can represent disclosure of embodiments in which only a single detector is provided, as well as disclosure of embodiments in which a plurality of such detectors are provided, and so forth.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of” For example, “at least one of A, B and C” explicitly includes only A, only B, only C, and combinations of each.

The word “or” as used herein means any one member of a particular list and, unless context dictates otherwise, can in alternative aspects include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

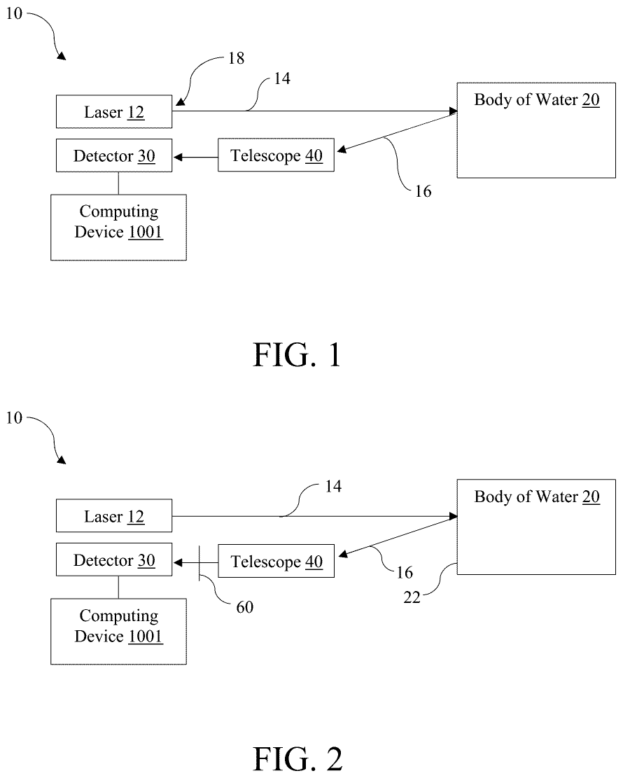

Disclosed herein, in one aspect, and with reference to FIG. 1, is a system 10 for determining a speed of a current in a body of water 20. A method for using the system 10 can comprise emitting light 14 from a laser emission source 12 into the body of water 20. A detector 30 can receive a reflection 16 of the light 14. The reflection 16 can be light that is scattered by the water and/or by particulates or objects in the water. In some aspects, a speed of a current in the body of water can be determined based on a Doppler-shifted frequency of the reflection of the light. In further aspects, a speed of an object in the body of water can be determined based on a Doppler-shifted frequency of the reflection of the light. For example, the system 10 can determine a speed of a fish, a submarine, a log, or any other object in the water.

The speed measured can be the magnitude of the velocity of the water, or object in the water, along an axis extending between the reflecting surface/particles and the detector 20. It is further contemplated that a plurality of speed measurements can be captured from different locations to determine the velocity of the water or the object in the water. For example, in some aspects, an outlet 18 of the laser emission source 12 and the detector 20 (or the entire system 10) can be moved to a plurality of locations positioned at different angular orientations relative to the body of water or object in the water. In further exemplary aspects, a plurality of laser emission sources 12 and detectors 20 can be used to simultaneously or in succession obtain respective speed measurements using the Doppler-shifted frequency of the reflection of the light, and the plurality of speed measurements can be used to resolve the velocity of the water or the object in the water using known trigonometric relationships within the system.

The laser emission source 12 can be a single frequency laser. The laser emission source 12 can emit light 14 having a wavelength that has low attenuation in water. For example, in some aspects, the laser emission source can be an Nd:YAG laser. In some aspects, the light from the laser emission source can be single frequency. In some aspects, the light can have a wavelength from about 200 nm to about 800 nm. For example, in some aspects, the light can have a wavelength from about 450 nm to about 550 nm. In exemplary aspects, the light can have a wavelength of 532 nm. For example, in some aspects, the laser emission source can be an Nd:YAG laser having a frequency-doubled emission. It is contemplated that the frequency can be selected for optimizing penetration through the body of water. For example, for use in an ocean, a frequency at or near blue light can have advantageous penetration. In some aspects, for the ocean, the wavelength can be from about 400 nm to about 500 nm, or about 450 nm. For example, for use in coastal or inland water, a frequency at or near green light can have advantageous penetration. In some aspects, for the ocean, the wavelength can be from about 500 nm to about 600 nm, or about 532 nm. In some optional aspects, the laser source can be a frequency-modulated laser.

Referring also to FIG. 2, in some aspects, the system 10 can be an incoherent system. Accordingly, in some aspects, the system 10 can be insensitive to phase of the reflected light). The reflection 16 of the light 14 can pass through a spectral filter 60 before entering the detector 30. In exemplary aspects, the spectral filter 60 can be an Etalon filter. The system 10 can be configured to determine the frequency of light received therein. Accordingly, a shift in frequency relative to the emitted frequency can correspond to the Doppler frequency shift. The Doppler frequency shift can be used to determine the speed of the current of the body of water or the speed of an object in the body of water.

In some exemplary aspects, the magnitude of the velocity vector can be measured parallel to the emission direction. Optionally, the passband of the spectral filter 60 can be slightly offset from the frequency of the light emitted from the laser so that a Doppler shift results in the power passing through the filter (and detected by the detector 20) increasing (or decreasing).

In some aspects, the laser emission source 12 can be locked to an absorption line of iodine gas, and iodine can be used as a filter for the reflected light at the detector 20. Any shift in the received light can move the reflected light out of the absorption line of iodine. Thus, an increase in the received light power can correspond to a Doppler shift.

In some aspects, the detector 30 can have a plurality of channels that can measure respective powers at different frequencies. For example, each channel can be associated with light passing through a filter having a different frequency passband. The power in each detector channel can be used to determine the Doppler frequency shift. For example, the power detected by each channel can correspond to a different amount of shifted frequency. Accordingly, Brillouin scattering and/or molecular scattering can be determined. For example, the scattering from molecules in the water can be shifted due to the Brillouin effect, giving the reflected light a ˜7.5 GHz frequency offset. Accordingly, a channel of the detector centered at this offset can be used measure the Brillouin-shifted molecular backscatter.

In some aspects, the system 10 can further comprise a pick-off that diverts a portion of the laser emission source 12 into the same or a separate detector. Light reflected by the pick-off can be monitored to account for variation in the output of the laser. For example, changes in power detected by the detector 20 can be compared to the relative changes in power of the light reflected by the pick-off to determine the extent to which the change in power is due to instability of the laser emission source 12 instead of changes due to Doppler frequency shift.

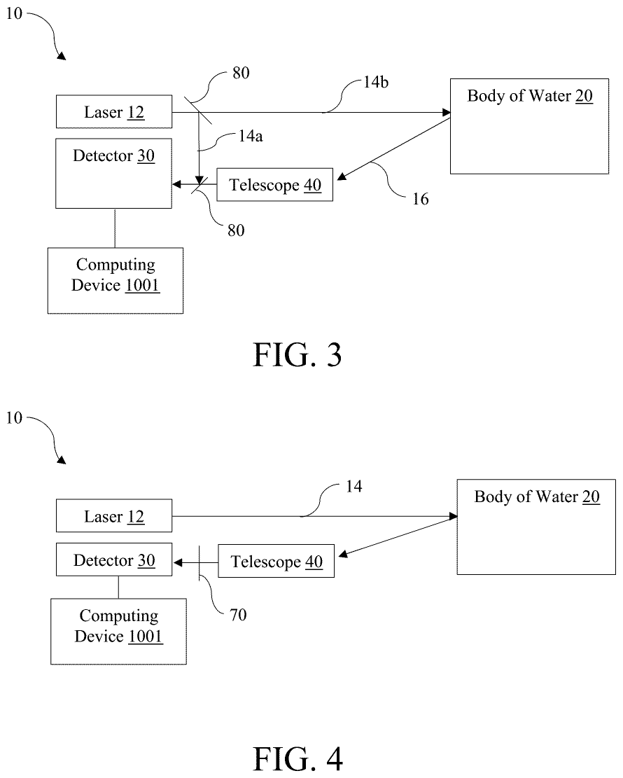

Referring also to FIG. 3, in some aspects, the system 10 can be a coherent system. Accordingly, in some aspects, the system 10 can be sensitive to phase of the reflected light. In these aspects, a first portion 14a of the light 14 can be split and directed to the detector 30. This first portion 14a can be referred to as a local oscillator. In some aspects, the first portion 14a of the light 14 can be delivered to the detector through free space (e.g., using one or more mirrors 80). In other aspects, the portion 14a of the light 14 can be delivered to the detector through optical fiber. A second portion 14b of the light 14 can be reflected by the water (or particles in the water) and returned to the detector 30, physically overlapping with the local oscillator either in free space or in a fiber. The received overlapping signals of the first portion 14a (local oscillator) and second portion 14b can provide a heterodyne downconversion comprising a sum frequency and a difference frequency between the local oscillator and the reflection 16. The difference frequency can be electrically detected and can correspond directly to the Doppler frequency.

The first portion 14a of the light 14 can be split by, for example, a beam splitter. The beam splitter can be, for example, partially transparent. In some aspects, the beam splitter can comprise a semi-transparent mirror (e.g., semi-transparent coating on a transparent substrate). In other aspects, the beam splitter can be free of a coating. The beam splitter can serve as a means for splitting the light from the laser emission source into a first portion and a second portion. However, it is contemplated that such means can be provided in the form of any equivalent structure that is capable of splitting the light as disclosed herein.

In some aspects, at least one mirror, at least one lens (optionally, a telescope), at least one fiber optic cable, or any combination thereof can serve as a means for directing the first portion of the light from the laser emission source to the detector. However, it is contemplated that such means can be provided in the form of any equivalent structure that is capable of directing the first portion of the light as disclosed herein.

In still further aspects, the overlapping first portion 14a (local oscillator) and reflection 16 can further be split and directed onto two photodetectors that are balanced. In this way, the intensity noise on the first portion 14a (local oscillator) can be canceled to improve (lower) the signal-to-noise ratio.

In some aspects, a polarizer (e.g., a polarizing filter) be used to increase the sensitivity of the system to the surface or sub-surface returns. For example, a polarizing filter oriented to be coincident with the output polarization of the laser can preferentially return light from a surface 22 of the water and scattered by water. A polarizing filter oriented to be crossed with the output of the laser can preferentially return light from below the surface and by particles and underwater objects. In some aspects, a liquid-crystal variable retarder (LCVR) can be used to electrically switch between the two polarizations.

Accordingly, referring to FIG. 4, the reflection 16 of the light 14 can be passed through a polarizing filter 70. In some aspects, the polarizing filter 70 can have a polarity that is coincident with a polarization of the light 14 emitted from the laser emission source. In other aspects, the polarizing filter 70 can have a polarity that is crossed with the polarization of the light from the laser emission source 12.

In some aspects, the polarizing filter 70 can comprise a mount, such as, for example, a housing, that supports the polarizing filter relative to the detector so that light passes through the polarizing filter 70 before entering the detector. The system can further comprise one or more optical elements (e.g., at least one mirror, at least one lens (optionally, a telescope), at least one fiber optic cable, or any combination thereof) for directing light through the polarizing filter 70. Said mount and/or said one or more optical elements can serve as a means for passing the reflection of the light through the polarizing filter. However, it is contemplated that such means can be provided in the form of any equivalent structure that is capable of passing the reflection of the light through the polarizing filter as disclosed herein.

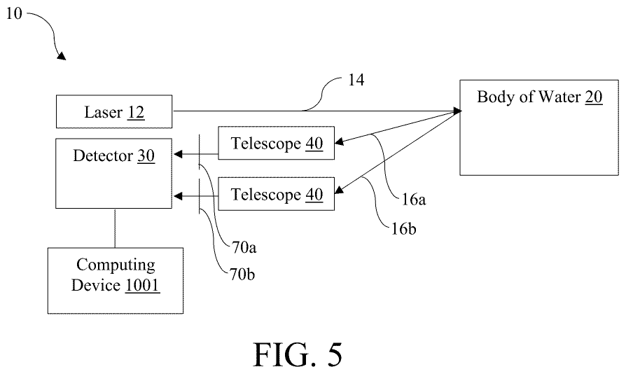

In still further aspects, and with reference to FIG. 5, a first portion 16a of the reflection 16 of the light 14 can be passed through a first polarizing filter 70a that is coincident with a polarization of the light from the laser emission source, and a second portion 16b of the reflection 16 of the light 14 can be passed through a second polarizing filter 70b that is crossed with a polarization of the light 14 from the laser emission source 12.

In some aspects, one or a plurality of mounts (e.g., housing) can be configured to support one or both of the first polarizing filter 70a and the second polarizing filter 70b so that the respective first portion 16a or second portion 16b passes therethrough. In some aspects, at least one mirror, at least one lens (optionally, a telescope), at least one fiber optic cable, the mount for the first polarizing mirror, or any combination thereof can serve as a means for passing the first portion of the reflection of the light through the first polarizing filter 70a that is coincident with a polarization of the light from the laser emission source. However, it is contemplated that such means can be provided in the form of any equivalent structure that is capable of passing the first portion of the reflection of the light through the first polarizing filter as disclosed herein.

In some aspects, at least one mirror, at least one lens (optionally, a telescope), at least one fiber optic cable, the mount for the second polarizing mirror, or any combination thereof can serve as a means for passing the second portion of the reflection of the light through the second polarizing filter 70b that is crossed with a polarization of the light from the laser emission source. However, it is contemplated that such means can be provided in the form of any equivalent structure that is capable of passing the second portion of the reflection of the light through the second polarizing filter as disclosed herein.

In some exemplary aspects, the reflection 16 of the light 14 can be focused on the detector 30 with a telescope 40 (e.g., a Galilean telescope). For example, in some aspects, the telescope can comprise a plurality of lenses. Optionally, the telescope 04 can comprise an iris. In some aspects, the laser emission source 12 can travel along an axis. In some aspects, the telescope can be generally axially parallel to the axis of the laser emission source. For example, in some aspects, the telescope can be within 10 degrees of, or within 5 degrees of, or within 3 degrees of, or within 2 degrees of, or within 1 degree of parallel to the axis of the laser emission source.

In some aspects, the light 14 from the laser emission source 12 can be continuous light. In other aspects, the light 14 from the laser emission source 12 can be pulsed light. It is contemplated that the pulsed light can provide a signal that can be digitized to measure the water current at each point sampled by a digitizer and thus create a current vs. depth profile. That is, the speed of light within water is known. Accordingly, the time delay from the emission of the light to the detection of the light can be used to calculate the distance from the detector at which the light was reflected. In these aspects, the method can further comprise determining a location at which the speed of the current in the body of water is measured (or a location at which the speed of the object in the water is measured). The location can be a distance from the outlet 18 of the laser emission source 12. It is contemplated that the laser can have a trigger output that can be used to determine an emission time of the laser. Based on the time delay, known speed of light in water, and sampling frequency, the range can be determined. For example, the range can be calculated or approximated as c*(S*t_s)/2, where c is the speed of light, t_s is the sample time (equivalent to one divided by the sample frequency), and S is the sample number.

In some aspects, the light 14 from the laser emission source 12 can be emitted into the body of water 20 by passing the light through a surface 22 of the water 20. In other aspects, the outlet 18 of the laser emission source can be immersed into the body of water 20.

The system 10 can comprise a laser emission source 12 that is configured to emit light into a body of water 20. The system 10 can further comprise a detector 30 that is configured to receive a reflection 16 of the light 14. A computing device 1001 can be in communication with the detector 30. The computing device 1001 can be configured to determine, based on a Doppler-shifted frequency of the reflection of the light, one of: a speed of a current in the body of water or a speed of an object in the body of water.

In some optional aspects, the laser emission source 12 can have an outlet 18 that is immersible in water.

### Computing Device

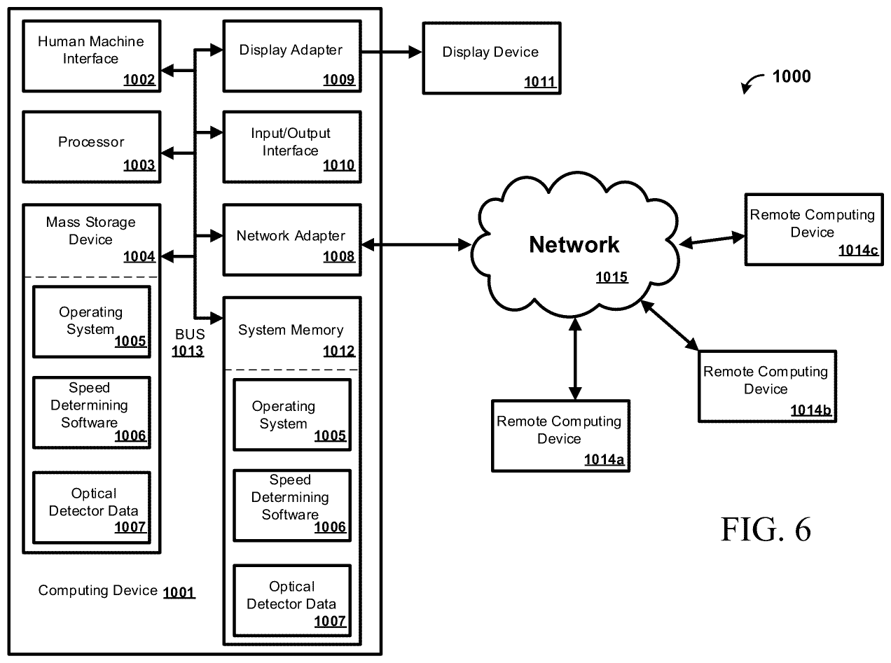

FIG. 6 shows a computing system 1000 including an exemplary configuration of a computing device 1001 for use with the systems and methods disclosed herein. The computing device 1001 can be configured to process data for determining speed of a current in a body of water or a speed of an object in the body of water. The computing device 1001 can be embodied as, for example, a stand-alone computing system (e.g., personal computer, tablet, smartphone, etc.), a cloud computing device, or a purpose-built computer.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as optical detector data 1007 (i.e., data from signals received by the wireless sub) and/or program modules such as operating system 1005 and speed determining software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and speed determining software 1006 may be stored on the mass storage device 1004. One or more of the operating system 1005 and speed determining software 1006 (or some combination thereof) may comprise program modules and the speed determining software 1006. The optical detector data 1007 may also be stored on the mass storage device 1004. The optical detector data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In some optional aspects, the remote computing devices 1014a,b,c can be in direct communication with each other and the computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

Although the foregoing invention has been described in some detail by way of illustration and example for purposes of clarity of understanding, certain changes and modifications may be practiced within the scope of the appended claims.

What is claimed is:

1. A method comprising:
emitting light from a laser emission source into a body of water;
receiving a reflection of the light at a detector; and
determining, based on a Doppler-shifted frequency of the reflection of the light, one of:
a speed of a current in the body of water; or
a speed of an object in a body of water.

2. The method of claim 1, further comprising passing the reflection of the light through a spectral filter.

3. The method of claim 1, further comprising:
splitting the light from the laser emission source into a first portion and a second portion; and
directing the first portion of the light from the laser emission source to the detector,
wherein the reflection of the light comprises a reflection of the second portion of the light from the laser emission source.

4. The method of claim 1, further comprising passing the reflection of the light through a polarizing filter.

5. The method of claim 4, wherein the polarizing filter is coincident with a polarization of the light from the laser emission source or crossed with a polarization of the light from the laser emission source.

6. The method of claim 1, further comprising:
passing a first portion of the reflection of the light through a first polarizing filter that is coincident with a polarization of the light from the laser emission source; and
passing a second portion of the reflection of the light through a second polarizing filter that is crossed with a polarization of the light from the laser emission source.

7. The method of claim 1, further comprising focusing the reflection of the light on the detector with a telescope.

8. The method of claim 1, wherein the light has a wavelength from 200 nm to 800 nm.

9. The method of claim 1, wherein the light has a wavelength of about 532 nm.

10. The method of claim 1, wherein the laser emission source is an Nd:YAG laser.

11. The method of claim 1, wherein the light from the laser emission source is pulsed light.

12. The method of claim 11, further comprising determining a location at which the speed of the current in the body of water is measured.

13. The method of claim 1, wherein the light from the laser emission source is one of continuous light and single frequency light.

14. The method of claim 1, wherein emitting the light from the laser emission source into the body of water comprises passing the light through a surface of the water.

15. The method of claim 1, wherein emitting the light from the laser emission source into the body of water comprises immersing an outlet of the laser emission source into the body of water.

16. A system comprising:
a laser emission source that is configured to emit light into a body of water;
a detector that is configured to receive a reflection of the light; and
a computing device that is in communication with the detector, wherein the computing device is configured to determine, based on a Doppler-shifted frequency of the reflection of the light, one of:
a speed of a current in the body of water; or
a speed of an object in a body of water.

17. The system of claim 16, wherein the laser emission source has an outlet that is immersible in water.

18. The system of claim 16, wherein the light has a wavelength from 200 nm to 800 nm.

19. A system comprising:
a laser emission source that is configured to emit light into a body of water, wherein the light has a wavelength from 200 nm to 800 nm;
means for splitting the light from the laser emission source into a first portion and a second portion;
a detector that is configured to receive a reflection of the light;
means for directing the first portion of the light from the laser emission source to the detector, wherein the reflection of the light comprises a reflection of the second portion of the light from the laser emission source;
means for passing the reflection of the light through a polarizing filter; and
a computing device that is in communication with the detector, wherein the computing device is configured to determine, based on a Doppler-shifted frequency of the reflection of the light, one of:
a speed of a current in the body of water; or
a speed of an object in a body of water.

20. The system of claim 19, further comprising:
means for passing a first portion of the reflection of the light through a first polarizing filter that is coincident with a polarization of the light from the laser emission source; and
means for passing a second portion of the reflection of the light through a second polarizing filter that is crossed with a polarization of the light from the laser emission source.
